(19) United States
(12) Patent Application Publication
(10) Pub. No.: US 2009/0159749 A1
(43) Pub. Date: Jun. 25, 2009

(54) CONNECTOR ELEMENT FOR CONNECTING TWO COMPONENT PARTS

(76) Inventors: Achim Etzkorn, Buxtehude (DE); Bengt Abel, Hamburg (DE); Herwig Assler, Hollern-Twielenfleth (DE)

Correspondence Address: PERMAN & GREEN, 425 POST ROAD, FAIRFIELD, CT, 06824, US

(21) Appl. No.: 12/264,535

(22) Filed: Nov. 4, 2008

Related U.S. Application Data
(60) Provisional application No. 61/014,759, filed on Dec. 19, 2007.

(51) Int. Cl. B64C 1/12

(52) U.S. Cl. 244/131

(57) ABSTRACT

A connector element for connecting two component parts which can be for example a fuselage skin which is connected to a ring frame segment. Alternatively the connector element can also serve as a frame coupling for connecting two ring frame segments. The component parts can be formed with the same materials or with different materials. According to the disclosed embodiments the connector element in the ideal case completely compensates a temperature-conditioned change in length of at least one of the component parts by varying a connector element length of the connector elements. Thus two component parts can be connected together with different materials such as for example a fuselage skin 6 of an aluminium alloy to a ring frame segment which is formed by carbon fibre reinforced epoxy resin. The different coefficients of thermal expansion in this design lead to different changes in length of the component parts which are compensated by a corresponding variation in the length of the connector element. The variation in the length of the connector element can take place (actively or passively) automatically or remote-controlled by means of suitable actuators integrated in the connector elements.

### CROSS REFERENCE TO RELATED APPLICATION

This application claims priority to, and the benefit of, U.S. Provisional Patent Application Ser. No. 61/014,759, filed on Dec. 19, 2007, the disclosure of which is incorporated herein by reference in its entirety.

### BACKGROUND

1. Field

The disclosed embodiments relate to a connector element for connecting two component parts in an aircraft, more particularly an aeroplane.

2. Brief Description of Related Developments

The supporting structure of aeroplanes was up until now made essentially universally of aluminium. To reduce the weight still further however there has been an increasing use of fibre-reinforced plastics for the supporting structure, such as for example carbon-fibre reinforced epoxy resin. The combination of aluminium materials with fibre-reinforced plastics for so-called “hybrid” components has however proved problematical in many respects. On the one hand problems of corrosion occur in the contact area between a component part of aluminium and a fibre-reinforced plastics, which can only be avoided by additional insulation measures. On the other hand metals, more particularly aluminium alloys, and fibre-reinforced plastics, such as for example carbon-fibre reinforced epoxy resins, have coefficients of thermal expansion which differ widely from one another. The widely differing coefficients of thermal expansion lead to mechanical stresses which can impair the integrity of the hybrid component part and/or its mechanical bearing capacity. Thus for example the coefficient of thermal expansion α_{Al} of aluminium is approximately 23*10⁻⁶ K⁻¹, whilst the coefficient of thermal expansion α_{CFK} of carbon-fibre reinforced epoxy resin is in the order of about 2*10⁻⁶ K⁻¹.

As a result of the circumstances mentioned above cost-intensive titanium alloys have been used up until now to connect component parts which have widely differing coefficients of thermal expansion.

### SUMMARY

The aspect of the disclosed embodiments is to substantially overcome the known disadvantages when connecting component parts which have coefficients of thermal expansion which differ widely from one another.

This is achieved through a connector element for connecting two component parts according to patent claim 1. Preferred embodiments form the subject of the dependent claims.

Since the connector element compensates for any temperature-conditioned change in length of at least one of the components by varying the length of a connector element, component parts having widely differing coefficients of thermal expansion, such as for example aluminium and fibre-reinforced plastics (composite components, carbon fibre reinforced plastics components) can be combined without problem for example without the risk of thermal stresses occurring which can lead to an impairment in the mechanical integrity and a reduction in the bearing capacity of the hybrid component part.

Alternatively it is also possible to join with the connector element component parts which indeed have substantially identical coefficients of thermal expansion α, in which case the thermally induced changes in length act however substantially in different directions and which thus nevertheless require a compensation of the changes in length in order to prevent mechanical stresses from occurring.

The variation in the length of the connector element can be carried out either “passively” and/or “actively”. In the case of a so-called passive change in the length of the connector element the variation takes place automatically through the respective temperature effect without any further action. A passively acting connector element is made of a material which has a direction-dependent and negative coefficient of thermal expansion. Suitable materials are for example thermoplastic or thermosetting plastics reinforced with carbon fibres or with Kevlar ® fibres.

Furthermore the connector element can be made with reinforcement fibre layers arranged in zigzag or concertina fashion one above the other. The connector element has in this case a number of superposed layers of reinforcement fibres each aligned unidirectionally. The superposed layers each run alternately at different (layer) angles of between 0° and 90° relative to one another.

Through the angular alignment of the layers it is possible to purposefully change, intensify or negate the ratio of the longitudinal expansion to the transverse expansion (transverse contraction). With a suitable design of the layer orientations in the connector element the expansion which occurs transversely to the direction of the required temperature length compensation regulates the respective temperature-conditioned expansion or contraction of the component parts which are to be connected.

Furthermore the connector elements can have shape-memory alloys which can “remember” two different lengths or positions in space in dependence on the temperature prevailing at the time. The passive configuration of the connector elements according to the disclosed embodiments has in particular the advantage that there is no necessity for a control and regulating device which is maintenance-intensive and liable to breakdown for controlling and injecting energy for actuators integrated into the connector elements for creating the corresponding change in the length of the connector element.

In the event of an “active” variation in the length of the connector element actuators are used which are energised remotely by means of control electronics and by injecting additional energy directly for a corresponding change in form. Examples of actuators suitable for this are for example materials having piezoelectric properties as well as carbon nanotubes wherein in both cases an additional electronic control and regulating device is required to couple the control signals and the required electrical energy. Alternatively shape memory alloys can also be used as actuators (so-called “memory” metals) which are triggered by electrical heating devices to produce the defined changes in length. The actuators are embedded where necessary together with a reinforcement fibre assembly into a plastics matrix or metal matrix to create the connector element.

The connector element according to the disclosed embodiments is preferably used as a so-called frame coupling for connecting ring frame segments into one complete ring frame. Furthermore the connector element for connecting ring frame segments or a complete ring frame is provided with an external skin of a fuselage cell of an aeroplane.

As a continuation of the disclosed embodiments it is proposed that the length of the connector element can be changed by at least one actuator which is controllable through an electric signal.

An active adaption of the relevant required length of the connector for compensating the different heat-conditioned changes in length of the component parts is hereby possible by means of an electronic control and regulating circuit.

In accordance with a further advantageous development the at least one actuator is designed as at least one piezoelectric element.

The use of piezoelectrically operating actuators for adapting the length of the connector element allows recourse to a fully developed and at the same time economically attractive technology. Furthermore the piezoelectric actuators can be easily miniaturised and integrated in existing connector element structures.

According to a further advantageous development it is proposed that the at least one actuator is formed with a plurality of carbon nanotubes.

Owing to the sub-microscopic dimensions of the carbon nanotubes compared with actuators which are formed with piezoelectric elements an even better integration into existing connector element structures is possible.

According to a further development of the disclosed embodiments the length of the connector element changes automatically in dependence on the external temperature.

A fail-safe temperature compensation of the change in length between the component parts is hereby possible because no separate control and regulating device for controlling the changes in length is required.

A further advantageous development of the disclosed embodiments proposes that the connector element is formed with a material which has a direction-dependent and at the same time negative coefficient of thermal expansion.

A fail-safe automatic change in the length of the connector element in dependence on the relevant prevailing external temperature is hereby possible. An additional control and regulating device for injecting the required energy and the control signals for operating the actuators for changing the length of the connector element—as absolutely essential in the case of the active design of the connector element—can be omitted.

Further features and advantages of the disclosed embodiments are apparent from the following description of preferred embodiments in which reference is made to the accompanying drawing.

### BRIEF DESCRIPTION OF THE DRAWINGS

FIG. 1 shows a side view of a connector element used for joining a ring frame segment to a fuselage skin.

FIG. 2 shows a side view of the assembled frame joint according to FIG. 1.

FIG. 3 shows a side view of a connector element designed as a frame coupling with two frame segments.

FIG. 4 shows a side view of the finished assembled frame coupling according to FIG. 3.

FIG. 5 shows the method of operation of a connector element.

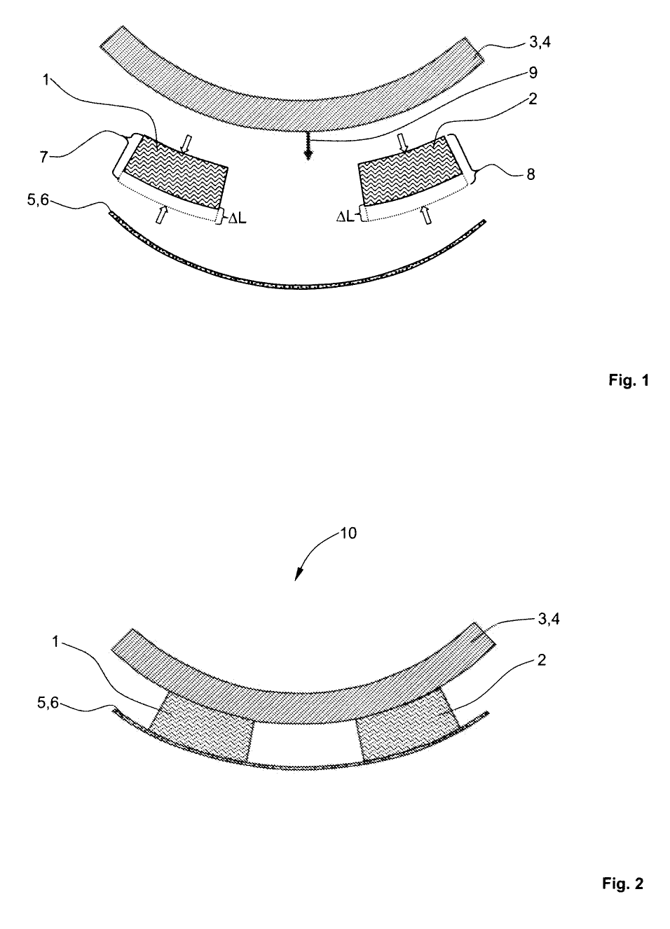

In the drawing the same structural elements each have the same reference numerals. In the following reference is made simultaneously to both FIGS. 1 and 2.

### DETAILED DESCRIPTION OF THE DRAWINGS

FIG. 1 shows two connector elements 1, 2 which are provided to connect a component part 3, more particularly a ring frame segment 4, to a further component part 5, more particularly to a fuselage skin 6 of an aeroplane.

The ring frame segment 4 is formed by way of example with a carbon fibre reinforced epoxy resin (CFK) and the fuselage skin 6 with an aluminium alloy material, or vice versa. The coefficient of thermal expansion α_{Al} of the aluminium alloys normally used in aircraft construction lies in the order of approximately 23* 10⁻⁶ K⁻¹ whilst the coefficient of thermal expansion α_{CFK} of carbon fibre reinforced epoxy resin moves in the range of about 2*10⁻⁶ K⁻¹. As a result of these coefficients of thermal expansion which can differ by a factor of more than 10 from one another, without the connector elements 1, 2 in the event of the temperature fluctuations within a range of between −50° C. and 85° C. which occur within air travel operation the result would be considerable mechanical stresses between the ring frame 4 and the fuselage skin 6, which in some circumstances could lead to the ring frame segment 4 becoming detached from the fuselage skin 6 in at least some areas. In a “basic state” of the connector elements 1, 2, that is at a room temperature of 20° C., these each have a (basic) connector element length 7, 8.

A downwardly directed black arrow on the ring frame segment 4 symbolises a temperature-induced change in length 9 of the ring frame segment 4 which is compensated by the connector elements 1, 2. The white arrows at the connector elements 1, 2 show the size and direction of the relevant change in length ΔL of the connector element length 7, 8.

As a result of this change in temperature there follows inter alia a change in length 9 of the ring frame segment 4 which in the ideal case is compensated completely by a corresponding contraction or shrinkage of the two connector element lengths 7, 8 of the connector elements 1, 2 by the amount ΔL in relation to the fuselage skin 6, so that no mechanical stresses occur between the ring frame segment 4 and the fuselage skin 6.

FIG. 2 shows a hybrid component part 10 in which the ring frame segment 4 is ultimately connected by the two connector elements 1, 2 to the fuselage skin 6 in the assembly position. The change in the lengths 7, 8 of the connector elements 1, 2 can take place either passively or actively.

With a passive alteration in the lengths 7, 8 of the connector elements the variation takes place directly through the temperature action. Passively operating connector elements 1, 2 are formed for example by materials which have a direction-dependent and/or negative coefficient of thermal expansion, such as for example most carbon fibre reinforced plastics or plastics reinforced with Kevlar® fibres. Alternatively the connector elements 1, 2 can be formed with shape memory alloys which in dependence on the ambient temperature prevailing at the time can “remember” two different positions or lengths and the length of which thus changes automatically dependent on temperature.

Alternatively the connector elements 1, 2 can be made with a number of superposed layers with reinforcement fibres which are embedded in a plastics and/or metal matrix. In each position the reinforcement fibres run unidirectionally, but the layers when considered per se each include (layer) angles between 0° and 90° relative to each other. The choice of the individual (layer) angles and the sequence of layers each with the different (layer) angles decides the resulting thermal expansion behaviour of the connector elements 1, 2. The ratio between a longitudinal expansion and a transverse expansion (i.e. the transverse contraction) of the connector elements 1, 2 is hereby defined, changed, increased or negated. Expansion effects of the connector elements 1, 2 which occur transversely to the direction of the required temperature length compensation substantially compensate for each temperature-conditioned expansion or contraction of the component parts which are to be connected.

Furthermore the possibility exists of providing the connector elements 1, 2 with actively operating actuators (not shown in these drawings), which are excited by a control and regulating device (not shown) to cause a change in length which in the ideal case completely balances the temperature-induced change in length of the component parts 1, 2. The actuators are integrated directly into the connector elements 1, 2 and can be formed for example by piezoelectric elements or carbon nanotubes.

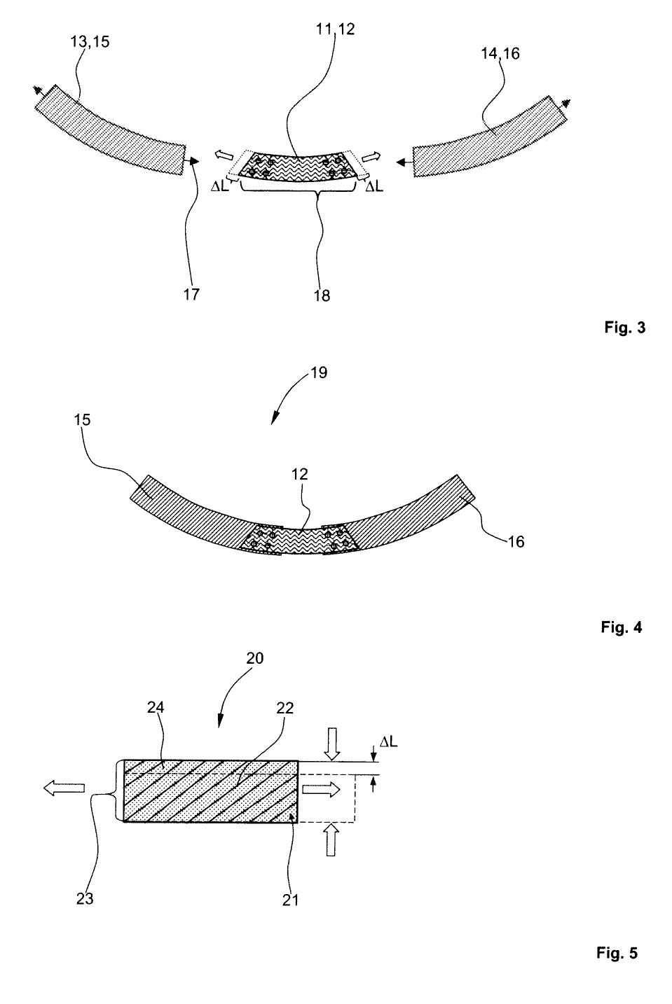

FIGS. 3 and 4 show an alternative embodiment of a connector element 11—more particularly a frame coupling 12—for connecting two component parts 13, 14, which can be in particular two ring frame segments 15, 16 for strengthening the fuselage cell of an aeroplane.

As opposed to the embodiment according to FIGS. 1 and 2 the two component parts 13, 14 in this case are made from the same material and consequently also have the same coefficients of thermal expansion, but the thermally induced changes in lengths of the two component parts 13, 14—as indicated by a black arrow 17 and the further non-designated black arrows—act in this design in opposite (anti-parallel) directions, mutually strengthen one another and therefore, to guard against the formation of mechanical stress, have to be compensated with the connector element 11.

The two ring frame segments 15, 16 are by way of example made from an aluminium alloy material with a carbon-fibre reinforced epoxy resin wherein the changes in length thereof caused by heat action are in the ideal case completely compensated by means of the frame coupling 12.

The four black arrows in FIG. 3 symbolize the direction of the thermally induced changes in lengths of the ring frame segments 14, 15 whilst the white arrows represent the direction of the change of one connector element length 18 by the amount ΔL. The connector element length 18 in turn relates to the “basic state”, that is that length of the connector element 11 or the frame coupling 12 which is set at the standard room temperature of 20° C.

FIG. 4 shows the two ring frame segments 15, 16 in the assembled position, that is in an installation position connected by the frame coupling 12 in a fuselage cell of an aeroplane. The two ring frame segments 15, 16 and the frame coupling together form one hybrid component part 19.

FIG. 5 shows the principal method of operation of one design version of a passively acting connector element.

A connector element 20 has several superposed layers with reinforcement fibres which are embedded in a plastics matrix of a thermosetting or thermoplastic plastics material. The reinforcement fibres each run unidirectionally in the layers, whilst the layers in the connector element 20 are each arranged at (layer) angles of between 0° and 90° relative to one another. FIG. 5 shows an upper layer 21 with a number of reinforcement fibres arranged therein whereby only one reinforcement fibre 22 is provided with a reference numeral as representative for all the other reinforcement fibres. The thermal expansion behaviour of the component part 20 can be influenced by a corresponding variation of the layer angle between 0° and 90° and a change in the layer sequence.

In a basic state, that is at room temperature of 20° C., the connector element 20 is located in a position illustrated by a solid line. If there is an increase in temperature, the connector element 20 expands either side in the direction of the horizontal white arrow until the position of the connector element 20 shown by the dotted outline is reached. Owing to the special layer arrangement the thermally produced horizontally occurring expansion of the connector element is transformed, as shown by the two oppositely aligned vertical white arrows, into a contraction movement which runs transversely to the longitudinal extension direction of the connector element 20. A connector element length 23 is hereby reduced by an amount ΔL. This reduction in the connector element length 23 by the amount ΔL is used according to the disclosed embodiments to compensate for the thermally conditioned length extensions of other component parts.

As reinforcement fibres 22 can be used by way of example carbon fibres, Kevlar® fibres, Aramid® fibres or other fibres having a corresponding thermal expansion behaviour. To form the connector element 20 the reinforcement fibres 22 are embedded into a plastics matrix 24, by way of example into an epoxy resin matrix or into a matrix of a mechanically ultra strong thermoplastics plastics.

In the case of active connector elements the actuators which serve to produce a controlled change in length are embedded into a plastics matrix. The actuators can where necessary form at the same time the reinforcement fibre arrangement required as a rule to strength the plastics matrix.

### LIST OF REFERENCE NUMERALS

1 Connector element
2 Connector element
3 Component part
4 Ring frame segment
5 Component part
6 Fuselage skin
7 Connector element length (basic state)
8 Connector element length (basic state)
9 Change in length (component part)
10 Hybrid component part
11 Connector element
12 Frame coupling
13 Component part
14 Component part
15 Ring frame segment
16 Ring frame segment
17 Change in length (component part)
18 Connector element length (basic state)
19 Hybrid component part
20 Connector element
21 Layer
22 Reinforcement fibre
23 Connector element length
24 Plastics matrix

1. A connector element for connecting two component parts in an aircraft, more particularly an aeroplane, wherein the connector element compensates a temperature-conditioned change in length of at least one of the component parts through a variation in the length of a connector element.

2. A connector element according to claim 1 wherein the connector element length can be changed by at least one actuator which can be controlled by an electric signal.

3. A connector element according to claim 1 wherein the at least one actuator is at least one piezoelectric element.

4. A connector element according to claim 1 wherein the at least one actuator is formed with a number of carbon nanotubes.

5. A connector element according to claim 1 wherein the connector element length changes automatically in dependence on the temperature.

6. A connector element according to claim 5 wherein the connector element is formed with a material which has a direction-dependent negative coefficient of thermal expansion.

7. A connector element according to claim 5 wherein the material is formed in particular with a carbon fibre reinforced plastics material and/or with a Kevlar® fibre reinforced plastics material.

8. A connector element according to claim 5 wherein the material is provided with a shape memory alloy.

9. A connector element according to claim 5 wherein the connector element is formed with a plastics material which is reinforced with a number of superposed layers each with unidirectionally running reinforcement fibres wherein the layers each run at an angle of between 0° and 90° relative to one another.

10. A connector element according to claim 1 wherein at least two component parts each have a different coefficient of thermal expansion α_{1,2} wherein the ratio α₁/α₂ between the two coefficients of thermal expansion reaches a value of at least 5.
